(19) United States
(12) Patent Application Publication
(10) Pub. No.: US 2014/0357343 A1
(43) Pub. Date: Dec. 4, 2014

(54) METHOD, SERVER, AND RECORDABLE MEDIUM FOR PROVIDING PREMIUM RECYCLING SERVICE

(71) Applicant: Intellectual Discovery Co., Ltd., Seoul (KR)

(72) Inventors: Dong Hurn Lee, Seoul (KR); Jae Ick Shin, Seoul (KR)

(73) Assignee: INTELLECTUAL DISCOVERY CO., LTD., Seoul (KR)

(21) Appl. No.: 14/364,009

(22) PCT Filed: Dec. 3, 2012
(86) PCT No.: PCT/KR2012/010383

§ 371 Date: Jun. 9, 2014

(30) Foreign Application Priority Data
Dec. 9, 2011 (KR) 10-2011-0132399
Dec. 9, 2011 (KR) 10-2011-0132415

(51) Int. Cl. A63F 13/40; A63F 13/58; A63F 13/33; A63F 13/50

(52) U.S. Cl. CPC A63F 13/40; A63F 13/50; A63F 13/58; A63F 13/33
USPC 463/22

(57) ABSTRACT

A method for providing a premium recycling service includes: a first stage for, when a user buys a uniform card, matching it with an ID, a proper identification code of the user and recording data of the bought uniform card; a second stage for, when there is an attempt to recycle an unused uniform card, receiving a uniform card to be recycled from the user; and a third stage for, when the user owns a recycling coupon, providing a uniform card with a price and a grade (hereinafter, recycling uniform card value) that are greater than an average price and a grade (hereinafter, average uniform card value) of the input uniform card to the user.

### TECHNICAL FIELD

The present invention relates to a method, server, and recordable medium for providing a premium recycling service, and it particularly relates to a method, server, and recordable medium for providing a premium recycling service for, when owning a recycling coupon, increasing sales of recycling coupons by additionally providing a predetermined value to a mean value of a card applied by a general recycling.

### BACKGROUND ART

In general, online games represent network-based games, they cover games executable through the Internet, they began to appear in the domestic market around the year 2000, and they are currently holding the limelight as 21st century leisure cultures for playing games with others in virtual reality.

The online game systems are divided into a multi-user dungeon (MUD) game and a multi-user graphical (MUG) game, and the MUD game is a system used in the earlier-stage online games and it progresses events in a text format and allows users to increase their levels.

On the contrary, the MUG game adds visual effects to the MUD game by using graphics, and the initial representative works of the MUG games are The Kingdom of the Winds by Nexon and Lineage by NCSoft.

The online games have various kinds of genres in a like manner of literature, particularly, roll playing games (RPG) with stories are classified into various genres, and recently, in a like manner of the movies, it has been enlarged to manufacture the games, and blockbuster-level games costing several tens of million dollars have been presented to the market.

As distribution of personal computers and Internet use has increased, the online games for a plurality of users to access a game server through the Internet and play the game together have been gradually increased, the initial-stage online games were limited to puzzles or board games in simple forms, and recently, sports games such as soccer have been serviced as online games.

When playing a soccer game serviced as an online game, a user progresses the soccer game as a director or a coach, that is, he hires and trains players who will join his team, and when a game opens, he chooses players and candidate players who will participate in the game, and decides positions of the players who are put in the game so that his team may win.

Game rules and skills used for the general soccer are applied to the online soccer games as they are, so users who like soccer may easily adapt to the online soccer game.

However, the online soccer game is not executed on a real playground but the user progresses the soccer game from the viewpoint of a director or a coach by manipulating a keyboard and a mouse so it is required for the online soccer game to allow the users to not lose interest but continue to enjoy the soccer game.

Korea Patent Laid-Open Publication No. 10-2011-0107081 filed by the present inventor according to the above-noted needs discloses a game server for providing a general uniform card that corresponds to a general player and a game-exclusive uniform card that corresponds to a game-exclusive player, its operation method, and a computer readable medium for recording an online soccer game program.

FIG. 1 shows a block diagram of a conventional game server. Referring to FIG. 1, the game server 100 includes a communicator 110, a UI generator 120, a uniform card provider 130, a player designator 140, a team organizer 150, and a controller 160.

The game server 100 includes a database for storing information relating to a uniform card that is an item provided to scout a player, and the information relating to a uniform card includes information on the players replaceable with a uniform card, money the user must pay to the game server 100 when buying a uniform card, and any sorts of information relating to various uniform cards such as capability points that may grow for respective players.

The uniform card provider 130 provides the uniform card, the uniform card is a kind of item provided by the game server 100 for the purpose of scouting players that are essential for playing the online soccer game, the uniform card may be provided for nothing by the game server 100 as a reward for game progress when the online soccer game is over, or it may be bought by the user when he pays a predetermined amount of money to the game server.

The uniform card may be one of two types, where one of them is a general uniform card replaceable with one of a plurality of general players, and the other is a game-exclusive uniform card replaceable with one of a plurality of exclusive players.

The general uniform card is a card replaceable with one of a plurality of general players, and when the general uniform card is opened by the user's choice, one of the general players is designated, and in this instance, the general player designated by opening the general uniform card may grow within a range of a growth capability points.

The game uniform card is a card replaceable with one of a plurality of game-exclusive players, and when the game-exclusive uniform card is opened by the user's choice, one of the game-exclusive players is designated, and the game-exclusive player designated by opening the game-exclusive uniform card may grow beyond a range of a growth capability threshold value.

However, the user may not be satisfied with the player when receiving the same by using a uniform card, and in this case, he may strongly feel deceived just like a case in which he lost a draw, so it is required to provide an item by which he may sell the uniform card again or use it and thereby remove his negative perception of the manufacturer, and an item for preventing the problem in which he buys an item such as a uniform card but fails to use it and leaves it unused is needed.

### DISCLOSURE

### Technical Problem

The present invention has been made in an effort to provide a method, a server, and a recordable medium for providing a premium recycling service for considering a fact that a user does not use an item when the item he does not desire comes out, providing an item for recycling an item to him, and increasing interest in a game.

The present invention has been made in another effort to provide a method, a server, and a recordable medium for providing a premium recycling service for, in addition to using a recycling item, further generating a recycling coupon so as to make a card coming out of a recycling item a better card, and allowing him to efficiently use a recycling service by allowing a recycling card with a higher numeric value to come out for a user who owns a recycling coupon.

The present invention has been made in another effort to provide a method, a server, and a recordable medium for providing a premium recycling service for increasing a number of users who use a premium recycling service for activating recycling and applying a recycling coupon when a recycling card with a higher numeric value may come out in the case of a user who owns a recycling coupon, and thereby increasing sales with a virtuous circulation that activates item purchases.

The present invention has been made in another effort to provide a method, a server, and a recordable medium for providing a premium recycling service for, when an item undesirable by a user comes out, allowing the user to recycle the item, and providing a prediction probability on the recycling item to him.

### Technical Solution

An exemplary embodiment of the present invention provides a method for providing a premium recycling service, including: a first stage for, when a user buys a uniform card, matching it with an ID that is a proper identification code of the user and recording data of the bought uniform card by a server; a second stage for, when the user does not use the uniform card and attempts to recycle it, receiving a uniform card to be recycled from the user by the server; and a third stage for providing a uniform card with a price and a grade corresponding to a predetermined range of a mean value of a value caused by a price and a grade of the input uniform card to the user.

Another embodiment of the present invention provides a method for providing a premium recycling service, including: a first stage for, when a user buys a uniform card, matching it with an ID that is a proper identification code of the user and recording data of the bought uniform card by a server; a second stage for, when the user does not use the uniform card and attempts to recycle it, receiving a uniform card to be recycled from the user by the server; and a third stage for, when the user owns a recycling coupon, providing a uniform card with a price and grade corresponding to a predetermined range of a mean value (B) that is a sum of a mean value (A) of values caused by the price and grade of the input uniform card and a predetermined value (α) to the user.

Another embodiment of the present invention provides a computer readable medium for recording a program, in a recordable medium for recording a program for executing a method for providing a premium recycling service, for realizing: a function for, when a user buys a uniform card, allowing a server to record data of the bought uniform card by matching the same and an ID, which is a proper identification code of the user; a function for, when the user does not use the uniform card and the user attempts to recycle it, allowing the server to receive the uniform card to be recycled from the user; and a function for providing a uniform card with a price and a grade corresponding to a predetermined range of a mean value of a value caused by a price and a grade of the input uniform card to the user.

Another embodiment of the present invention provides a computer readable medium for recording a program, in a recordable medium for recording a program for executing a method for providing a premium recycling service, for realizing: a function for, when a user buys a uniform card, allowing a server to record data of the bought uniform card by matching the same and an ID, which is a proper identification code of the user; a function for, when the user does not use the uniform card and the user attempts to recycle it, allowing the server to receive the uniform card to be recycled from the user; and a function for, when the user owns a recycling coupon, providing a uniform card with a price and grade corresponding to a predetermined range of a mean value (B) that is a sum of a mean value (A) of values caused by the price and grade of the input uniform card and a predetermined value (α) to the user.

Another embodiment of the present invention provides a server for providing a premium recycling service including: a communicator connected in a wired or wireless manner for transmitting/receiving data; a controller for controlling respective constituent elements; a storage unit for, when a user buys a uniform card through the communicator, matching the same with the user's ID, and storing the same; and a recycling service provider for, when the user's request to recycle a uniform card is input to the communicator, allowing the controller to output the ID that is input to the storage unit and data of the uniform card according to the request that is input through the communicator, receiving the same, and outputting a recycling result.

### Advantageous Effects

As described above, the embodiments of the present invention allow \textcircled{1} considering a fact that a user does not use an item when the item he does not desire comes out, providing an item for recycling an item to him, and increasing interest in the game, \textcircled{2} in addition to using a recycling item, further generating a recycling coupon so as to make a card coming out of a recycling item a better card, and allowing him to efficiently use a recycling service by allowing a recycling card with a higher numeric value to come out for the user who owns a recycling coupon, and \textcircled{3} increasing a number of users who use a premium recycling service for activating recycling and applying a recycling coupon when a recycling card with a higher numeric value may come out in the case of a user who owns a recycling coupon, and thereby increasing sales with a virtuous circulation that activates item purchases. Further, the embodiments of the present invention allow \textcircled{4} when an item undesirable by a user comes out, allowing the user to recycle the item and providing a prediction probability on the recycling item to him.

### DESCRIPTION OF THE DRAWINGS

FIG. 1 shows a block diagram of a conventional game server.

FIG. 2 shows a block diagram of a server for providing a premium recycling service according to an exemplary embodiment of the present invention.

FIG. 3 shows a process for driving a server for providing a premium recycling service according to an exemplary embodiment of the present invention.

FIG. 4 shows a process for driving a server for providing a server for providing a premium recycling service according to one exemplary embodiment of the present invention.

FIG. 5 shows a flowchart of a method for providing a premium recycling service according to an exemplary embodiment of the present invention.

FIG. 6 shows a flowchart of an exemplary method for providing a premium recycling service according to an exemplary embodiment of the present invention.

FIG. 7 shows a premium recycling service according to an exemplary embodiment of the present invention.

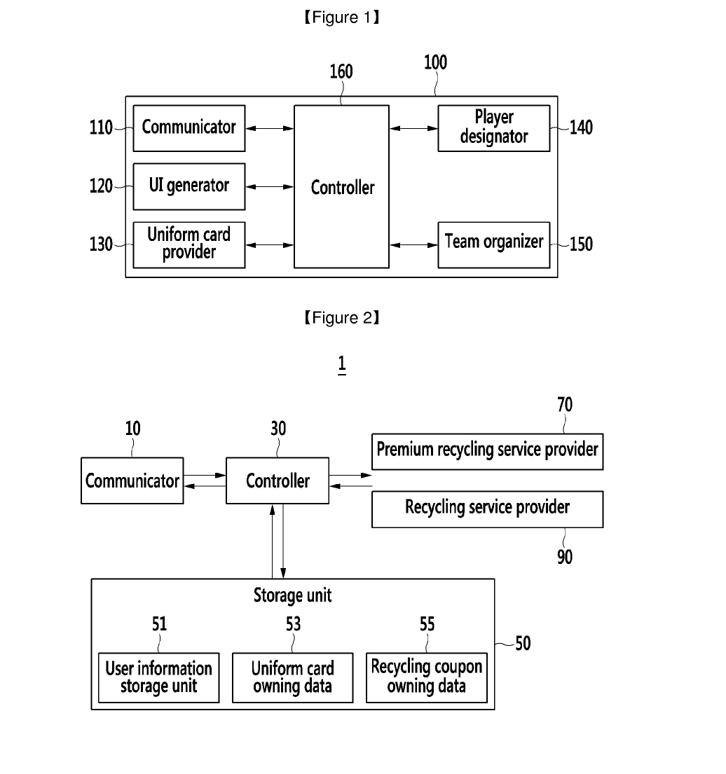

### MODE FOR INVENTION

Descriptions on the disclosed skill are exemplary embodiments for a structural or functional description, and the scope of the disclosed skill is not to be understood to be restricted by the exemplary embodiment described in the specification. That is, it is to be understood that the exemplary embodiment is intended to cover various modifications and equivalent arrangements included within the spirit and scope of the appended claims. Further, the proposed objects or effects in the disclosed technique do not signify that a specific exemplary embodiment may include all of them or include the effects, so the scope of the disclosed skill is not to be understood to be restricted by the exemplary embodiment described in the specification.

In addition, terms that are described in the present invention are to be understood as follows.

Terms such as “first,” “second,” etc., may be used to distinguish one constituent element from another constituent element, and the scope must not be restricted by the terms. For example, a first constituent element may be called a second constituent element, and similarly, the second constituent element may be called the first constituent element.

It is noted that when it is described that a certain constituent element is “connected” to another constituent element, they may be directly connected or electrically connected to each other but a third constituent element may exist therebetween. On the contrary, it is also noted that when it is described that a certain constituent element is “directly connected” or “directly electrically connected” to another constituent element, a third constituent element does not exist therebetween. In addition, other expressions that describe relationships among constituent elements such as, “between,” “just between,” or “adjacent to” and “directly adjacent to” must be understood in a like manner.

An expression used in the singular encompasses an expression of the plural, unless it has a clearly different meaning in the context, and it is to be understood that terms such as “including,” “having,” etc. are intended to indicate the existence of features, numbers, steps, actions, components, parts, or combinations thereof disclosed in the specification, and are not intended to preclude the possibility that one or more other features, numbers, steps, actions, components, parts, or combinations thereof may exist or may be added.

Identification codes (e.g., a, b, c, etc.,) in respective stages are used for better comprehension and ease of description, but they do not necessarily describe an order of the respective stages, and the respective stages may be performed in an different order from the described order unless a specific order is written in the context. That is, the respective stages may be performed according to the described order, they may be performed substantially simultaneously, and they may be performed in an opposite order.

The present invention can be implemented as a computer-readable code in a computer-readable recording medium, and the computer-readable recording medium includes all types of recording apparatuses in which data that can be read by a computer system is stored. Examples of the computer-readable recording media include a ROM, a RAM, a CD-ROM, a magnetic tape, a floppy disk, an optical data storage unit, a non-memory semiconductor, etc., and in addition, they include a recording medium implemented in the form of a carrier wave (for example, transmission through the Internet). The computer readable recording medium may also be distributed to computer devices connected by a network so that the computer readable codes are stored and executed in a distributed fashion.

In addition, unless defined otherwise in the detailed description, all the terms have the same meaning as meanings generally understood by those skilled in the art to which the present invention pertains. Generally used terms such as terms defined in a dictionary should be interpreted as the same meanings as meanings within a context of the related art and should not be interpreted as ideally or excessively formal meanings unless clearly defined in the present specification.

An exemplary embodiment of the present invention will now be described in detail with reference to accompanying drawings.

FIG. 2 shows a block diagram of a server for providing a premium recycling service according to an exemplary embodiment of the present invention. Referring to FIG. 2, the server 1 for providing a premium recycling service according to an exemplary embodiment of the present invention includes a communicator 10, a controller 30, a storage unit 50, a premium recycling service provider 70, and a recycling service provider 90.

The communicator 10 is connected to a plurality of clients in a wired or wireless manner to receive respective clients' keyboard manipulations, and when there is a request for buying a recycling coupon for a premium recycling service of the user and buying an item such as a uniform card, the communicator 10 outputs it to the controller 30 so that it may be stored in the storage unit 50 for each client, and when there is an attempt at recycling, the communicator 10 receives the data output by the premium recycling service provider 70 and the recycling service provider 90 through the controller 30 based on the data of the storage unit 50, and transmits the data to the client.

In the present embodiment, the client is defined to be an opposite concept of a server indicating the computer for supplying information, and the user is defined to be a natural person who manipulates the client.

The controller 30 is configured to control respective constituent elements, it is an input/output path of outputs that are output by the constituent elements, and when the data that are output by a plurality of clients are input through the communicator 10, it is configured to output the data of the storage unit 50 to the communicator 10 so that the data may be output from the storage unit 50 and may then be transmitted to the client.

The storage unit 50 includes a user information storage unit 51, uniform card owning data 53, and recycling coupon owning data 55, and the user information storage unit 51 receives a proper identification code such as an ID so as to distinguish the user manipulating each client.

The uniform card owning data 53 stores data on whether the user owns a uniform card and what grade of and how many uniform cards he owns, and when the premium recycling service is provided and there is a recycling coupon, a card with a higher grade and value may come out so the recycling coupon owning data 55 may store how many of them he owns. Here, the recycling coupon may receive the premium recycling service depending on whether there is a recycling coupon, and it is possible to set that the card with much higher grade and price may come out in a linear or stepwise manner in proportion to a price, grade, and number of the recycling coupons, which may be modifiable in various ways and may be set optionally or with a combination, which will be obvious.

In one exemplary embodiment, the storage unit 50 may include item owning data. Here, the item owning data may be stored data on what grade and how many items other than the uniform card he owns.

In the present specification, a predetermined number of uniform cards can be inserted into a recycling box, the uniform card can be continuously inserted into it without restriction of the number, and when there is another item, it can also be inserted into it so the cards with a further higher grade and price can come out depending on the uniform card, item's grade, price, and number.

Therefore, it can be possibly set that the card with a higher grade and price comes out in a linear or stepwise manner in proportion to the uniform card, item's number, price, and grade, which may be modifiable in various ways and may be set optionally or with a combination, which will be obvious.

The premium recycling service provider 70 provides a recycling service for the users who buy the recycling coupon or have it as complimentary and own it, a general recycling service is provided as a default, and when he owns a recycling coupon, the card with a higher grade and price may come out to him.

That is, the premium recycling service provider 70 receives data on which uniform card the user inserted into it from the user's input based on the recycling coupon data 55 and the uniform card owning data 53, determines a type of the card to come out as a result of recycling based on the recycling coupon data 55 and the uniform card owning data 53, and outputs the same to the user.

Here, the uniform card is one of items of which various price bands are formed according to various grades and which are exchangeable with players having stats, that is, capability points, that are better as the price of the uniform card becomes higher.

When a predetermined number of uniform cards to be recycled are put into the recycling box, the recycling service provider 90 receives data on which and how many uniform cards he put into it from the user's input, determines the type of the card that will come out as a recycling result based on the uniform card owning data 53, and outputs the same to the user in order to provide the card that satisfies the uniform card's grade, price, and mean value.

In one exemplary embodiment, each time the item or the uniform card is put into the recycling box, the recycling service provider 90 may provide a service so as to show a probability by which a good card may come out in proportion to the grade and the price of the card or the item to the user.

That is, the recycling service provider 90 is configured, each time the item or the uniform card is put into the recycling box, to receive the data on which uniform card or which item, and how many of which the user put into it from the user's input, and to output the probability by which the good card that is a result of recycling to the user based on the uniform card owning data 53 and the item owning data.

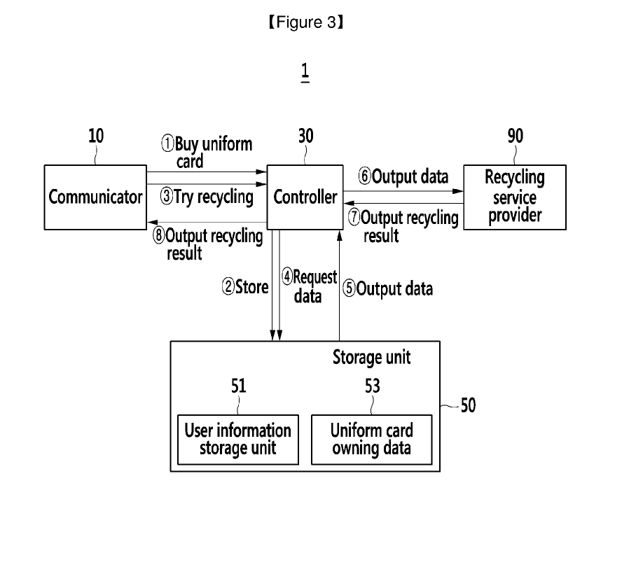

FIG. 3 shows a process for driving a server for providing a server for providing a premium recycling service according to an exemplary embodiment of the present invention. As shown in FIG. 3, when the user buys a uniform card \textcircled{1}, the communicator 10 outputs it to the controller 30, and the controller 30 matches it with the ID of the user information storage unit 51 of the storage unit 30 and stores it in the uniform card owning data 53 \textcircled{2}.

When the buying of a uniform card is repeated, the storing is repeated, and if the user dislikes the card he bought or desires to change it to thus attempt recycling \textcircled{3}, the controller 30 receives it, checks what card he has up to now, compares it with the card he attempts to recycle, authorizes it, and requests data \textcircled{4} to output the data from the storage unit 50 \textcircled{5}.

The data that are input to the controller 30 are output to the recycling service provider 90 \textcircled{6}, and the recycling service provider 90 outputs a card within a predetermined range of a value summed and averaged according to the owned uniform card's grade and price to the user, which is expressed in Equation 1, and without being restricted to the equation, the outputting of cards that are within a predetermined range of a mean value of the owning card is included in the scope of the present exemplary embodiment.

$$\frac{{\sum }_{n = 1}^{N} An}{N} \qquad ( Equation 1 )$$

Here, A is a value induced by the owned uniform card's price and grade, n is a number of the uniform card, a summation is possible from 1 to N, and division by N is used to find an arithmetic mean.

When the mean value is found as expressed in Equation 1, a card within a predetermined range is supplied to the user, which is expressed in Equation 2.

$$\frac{{\sum }_{n = 1}^{N} An}{N} - α \leq Card to come out as recycling result \leq \frac{{\sum }_{n = 1}^{N} An}{N} + α \qquad ( Equation 2 )$$

That is, it is to have a card with a predetermined range of the mean value come out, which allows a card that is not less than a bottom limit value of the card he put into it to come out, and prohibits a card that is greater than a top limit value of the card he put into it to come out.

Therefore, the probability by which a card comes out within a predetermined range of the mean value of the card he put into it is set to be high, and the probability by which a card that is greater than the card he put into it is set to be low, thereby performing recycling.

When the recycling service provider 90 performs recycling, sets the probability for the card that is high compared to investment to be low and the probability for a card that is similar compared to investment to be high to thus perform recycling, and outputs a corresponding result to the controller 30 \textcircled{7}, the controller 30 transmits the data to the communicator 10 so as to output a recycling result to the user \textcircled{8}, and controls the same to be transmitted to the user.

A process for driving a server for providing a premium recycling service according to another exemplary embodiment of the present invention will now be described with reference to FIG. 3.

When the user buys a uniform card \textcircled{1}, the communicator 10 outputs it to the controller 30, and the controller 30 matches it with the ID of the user information storage unit 51 of the storage unit 30 and stores it in the uniform card owning data 53 \textcircled{2}.

When the buying of a uniform card is repeated, the storing is repeated, and if the user dislikes the card he bought or desires to change it to attempt a recycling \textcircled{3}, the controller 30 receives it, checks what card he has up to now, compares it with the card he attempts to recycle, authorizes it, and requests data \textcircled{4} to output the data from the storage unit 50 \textcircled{5}.

The data that are input to the controller 30 are output to the recycling service provider 90 \textcircled{6}, and the recycling service provider 90 outputs the probability by which a good card within a predetermined range of the value summed according to the owned uniform card's grade and price to the user, which is expressed in Equation 1, and without being restricted to the equation, the outputting of the probability that is proportional to the sum of the grades of the owned cards is included in the scope of the present exemplary embodiment.

In Equation 1, A is a value induced by the owned uniform card's price and grade, n is a number of the uniform card, and the summation thereof shows an increase of the probability according to the number of cards so the probability is increased according to the price, grade, and number.

Therefore, the probability is determined in proportion to the price, grade, and number of cards he put into it and is then displayed to him, the probability for the good card to come out is reduced when he put the cards of low price, grade, and number, the probability for the good card to come out is increased when he put the cards of high price, grade, and number, the probability for the good card to come out may be increased when he put the cards of low price and great number, and the probability may be proportional to various combinations.

When the recycling service provider 90 performs recycling, sets the probability for the card that is high compared to investment to be low and the probability for a card that is similar compared to investment to be high to thus perform recycling, and outputs a corresponding result to the controller 30 \textcircled{7}, the controller 30 transmits the data to the communicator 10 so as to output a recycling result to the user \textcircled{8}, and controls the same to be transmitted to the user.

A process for driving a server for providing a premium recycling service according to the other exemplary embodiment of the present invention will now be described with reference to FIG. 3.

When the user buys a uniform card and an item \textcircled{1}, the communicator 10 outputs them to the controller 30, and the controller 30 matches them with the ID of the user information storage unit 51 of the storage unit 30 and stores them in the uniform card owning data 53 and the item owning data \textcircled{2}.

When the buying of a uniform card and an item is repeated, the storing is repeated, and the user dislikes the card he bought or desires to change it to attempt recycling \textcircled{3}, the controller 30 receives it, checks what card he has up to now, compares it with the card he attempts to recycle, authorizes it, and requests data \textcircled{4} to output the data from the storage unit 50 \textcircled{5}.

The data that are input to the controller 30 are output to the recycling service provider 90 \textcircled{6}, and the recycling service provider 90 outputs the probability by which a good card within a predetermined range of the value summed according to the owned uniform card and item's grade and price to the user, which is expressed in Equation 3, and without being restricted to the equation, the outputting of the probability that is proportional to the sum of the grades of the owned cards and items is included in the scope of the present exemplary embodiment.

$${\sum }_{n = 1}^{N} An + {\sum }_{m = 1}^{M} Bm \qquad ( Equation 3 )$$

Here, A is a value induced by the owned uniform card's price and grade, n is a number of the uniform card, and the summation thereof shows an increase of the probability according to the number of cards so the probability is increased according to the price, grade, and number.

As described, B is a value following the owned item's price and grade, m is a number of items, and a summation thereof shows an increase of the probability depending on the number of items, so the probability is increased according to the price, grade, and number.

Therefore, the probability is determined in proportion to the price, grade, and number of the items and cards he put into it and is then displayed to him, the probability for the good card to come out is reduced when he put the cards of low price, grade, and number, the probability for the good card to come out is increased when he put the cards of high price, grade, and number, the probability for the good card to come out may be increased when he put the cards of low price and great number, and the probability may be proportional to various combinations.

When the recycling service provider 90 performs recycling, sets the probability for the card that is high compared to investment to be low and the probability for a card that is similar compared to investment to be high to thus perform recycling, and outputs a corresponding result to the controller 30 \textcircled{7}, the controller 30 transmits the data to the communicator 10 so as to output a recycling result to the user \textcircled{8}, and controls the same to be transmitted to the user.

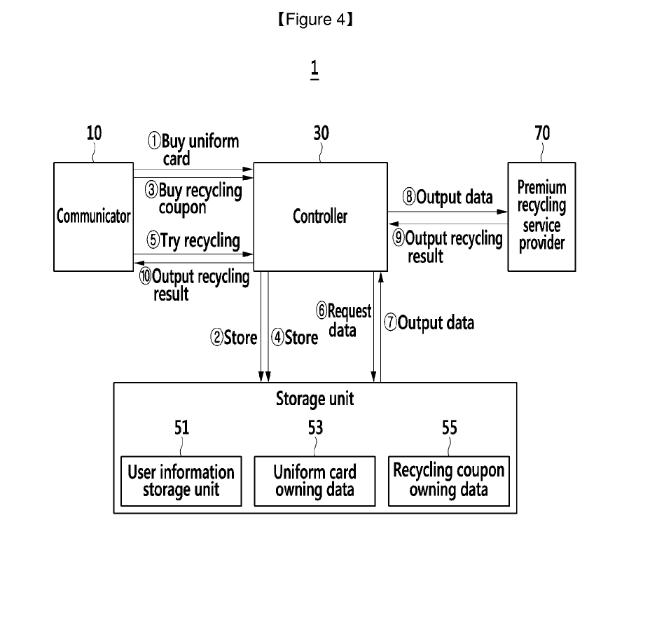

FIG. 4 shows a process for driving a server for providing a server for providing a premium recycling service according to one exemplary embodiment of the present invention. As shown in FIG. 4, when the user buys a uniform card \textcircled{1}, the communicator 10 outputs it to the controller 30, and the controller 30 matches it with the ID of the user information storage unit 51 of the storage unit 30 and stores it in the uniform card owning data 53 \textcircled{2}.

Further, when he buys a recycling coupon together with it \textcircled{3}, the controller 30 stores it into the recycling coupon data 55 \textcircled{4}, when the buying of a uniform card and an item is repeated, the storing is repeated, and if the user dislikes the card he bought or desires to change it to attempt recycling \textcircled{5}, the controller 30 receives it, checks what card he has up to now, compares it with the card he attempts to recycle, authorizes it, and requests data \textcircled{6} to output the data from the storage unit 50 \textcircled{7}.

The data that are input to the controller 30 are output to the premium recycling service provider 70 \textcircled{8}, and since the premium recycling service provider 90 owns a recycling coupon, it performs a summation according to the owned uniform card's grade and price and outputs a card within a predetermined range of the mean value to the user, allows the card with higher price and grade since it owns the recycling coupon, which is expressed in Equation 4, and without being restricted to the equation, the coming out of the card with a price and a grade that are higher than a predetermined range of the mean value of the owned card is included in the present exemplary embodiment.

$$\frac{{\sum }_{n = 1}^{N} An}{N} + α \qquad ( Equation 4 )$$

Here, A is a value induced by the owned uniform card's price and grade, n is a number of the uniform card, a summation is possible from 1 to N, division by N is to find an arithmetic mean, and a is to have a card with a higher price and grade come out since there is a recycling coupon.

When the mean value is set as expressed in Equation 3, a card with a predetermined range is supplied to the user, which is expressed in Equation 5.

$$\frac{{\sum }_{n = 1}^{N} An}{N} + α - α \leq Card to come out as recycling result \leq \frac{{\sum }_{n = 1}^{N} An}{N} + α + α \qquad ( Equation 5 )$$

That is, it is to allow a card with a predetermined range of the mean value, which allows the card that is not lower than the bottom limit value of the card he put into it to come out and prevents the card that is higher than the top limit value of the card he put into it from coming out, and since he owns a recycling coupon in this case, the card having a greater value than the general recycling comes out.

Therefore, the probability to come out within a predetermined range of the mean value of the card he put into it is set to be high, and the probability for the card that is greater than the card he put into it is set to be low, thereby progressing recycling.

The premium recycling service provider 70 progresses recycling, sets the probability by which a card that is high compared to investment comes out as low, and sets the probability by which a card that is similar compared to investment comes out as high to progress recycling, and when there is a recycling coupon, the grade and the price of the card to come out are set to be high and are then output, and a corresponding result is output to the controller 30 \textcircled{9}, the controller 30 transmits the data to the communicator 10 so as to output the recycling result to the user \textcircled{10}, and controls the same to be transmitted to the user.

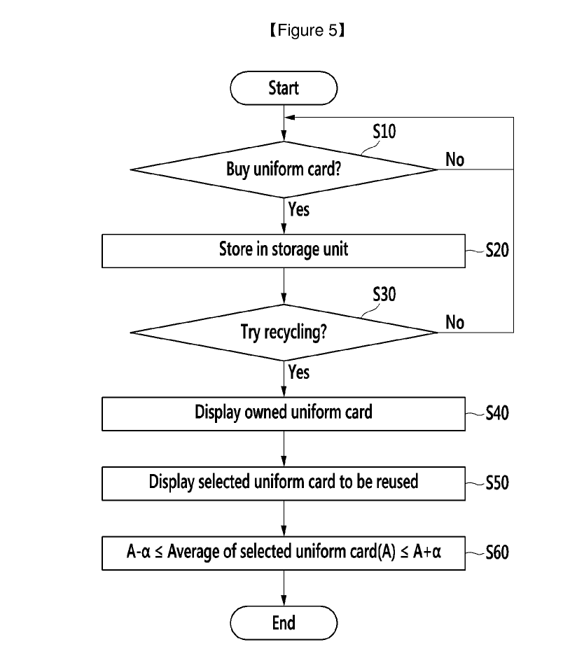

FIG. 5 shows a flowchart of a method for providing a premium recycling service according to an exemplary embodiment of the present invention. As shown in FIG. 5, a method for providing a recycling service for notifying a prediction probability according to an exemplary embodiment of the present invention may begin when the user owns a uniform card (S10).

Through the communicator, the data on the user's buying of a uniform card are stored in the storage unit through the controller (S20), and when the user owns a predetermined number of uniform cards, and dislikes them or desires to exchange them with others to attempt recycling (S30), the controller receives the data through the communicator, and the controller outputs the user's ID input into the storage unit and the owned uniform card to the communicator so that they may be output to the user (S40).

When the owned uniform card is displayed to the user and he selects the uniform card to be recycled by an operation such as a click or a mouse over, the selected uniform card to be recycled is displayed to the user (S50).

The mean value of the grade and the price of a predetermined number of uniform cards is proportional to the probability by which a good card will come out and the probability by which a good card will come out is increased when the number of uniform cards is increased, so the number may be set to be proportional to the probability.

Therefore, the probability to have a good card come out is increased so as to be proportional to the grade, price, and number of the uniform cards he put into the recycling box, and in the general case, the mean value (A) of the selected uniform card has a predetermined range, that is, A−α to A+α values, the probability for a card with a grade that is higher than that he put into it is set to be low, and the probability for a card with a similar grade to come out is set to be equal (S60).

In the case of notifying a prediction probability for the probability by which a good card will come out to be proportional to the grade, price, and number of the uniform cards he put into the recycling box according to an exemplary embodiment of the present invention, an expectation result is increased when he put the card with high grade and price each time he puts one card into the recycling box, and it is immediately shown to the user so he will put the cards with better grade and price into the same so as to increase the probability for a better card to come out.

Accordingly, consumption of the uniform cards owned by the user will be accelerated and he will buy the uniform cards of as many as have disappeared, which will make a virtuous cycle of an increase of sales of uniform cards.

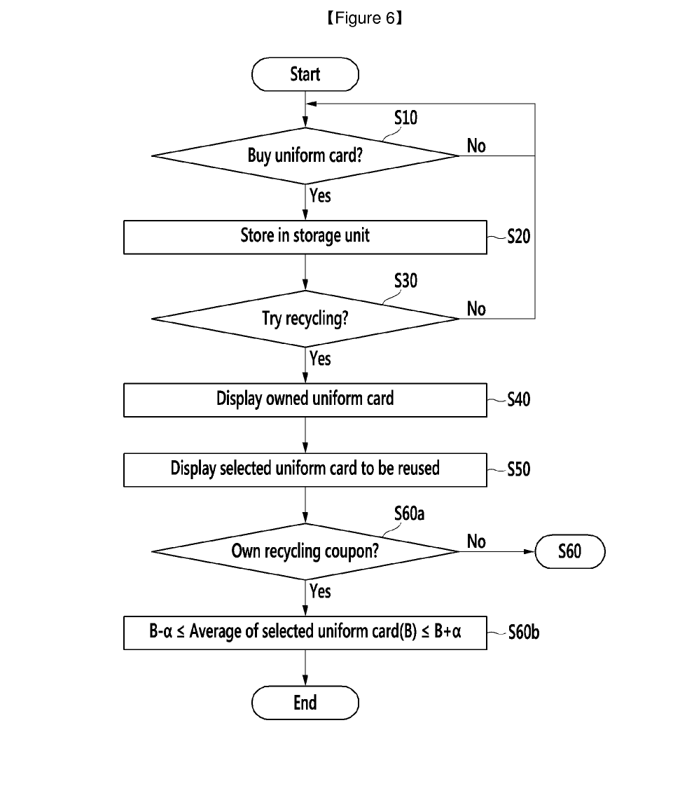

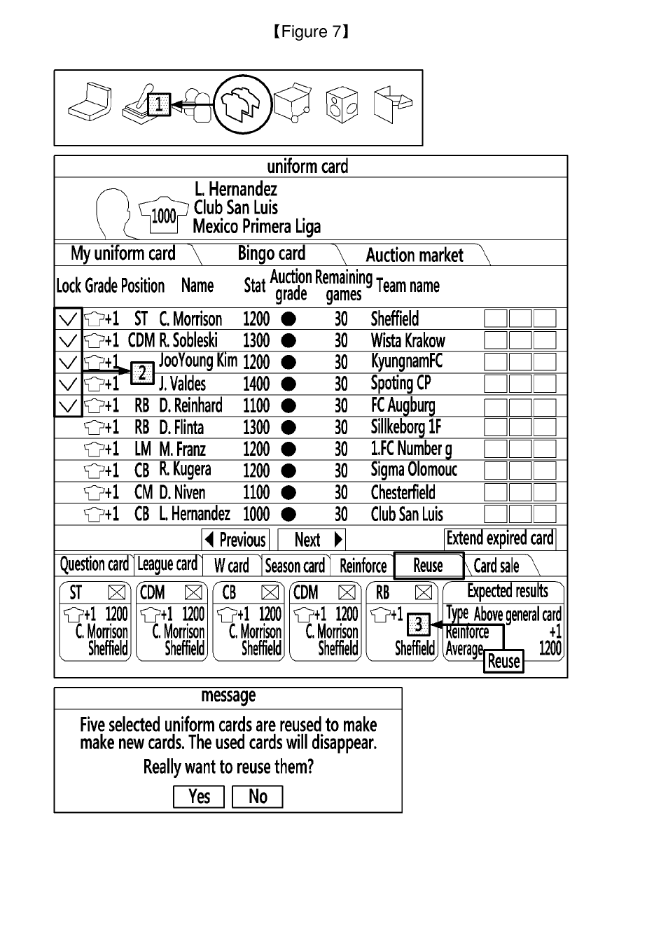

FIG. 6 shows a flowchart of an exemplary method for providing a premium recycling service according to an exemplary embodiment of the present invention. A method for providing a recycling service for notifying a prediction probability according to an exemplary embodiment of the present invention may begin when the user owns a uniform card (S10).

Through the communicator, the data on the user's buying of a uniform card are stored in the storage unit through the controller (S20), and when the user owns a predetermined number of uniform cards, and dislikes them or desires to exchange them with others to attempt recycling (S30), the controller receives the data through the communicator, and the controller outputs the user's ID input into the storage unit and the owned uniform card to the communicator so that they may be output to the user (S40).

When the owned uniform card is displayed to the user and he selects the uniform card to be recycled by an operation such as a click or a mouse over, the selected uniform card to be recycled is displayed to the user (S50).

Here, when he owns no recycling coupon, the premium recycling service is not provided so it goes to the step S60, and when he owns a recycling coupon, it is set such that a card with a predetermined range for the mean value (A+α=B) that is greater than the mean value (A) of the selected uniform card may come out (S60b).

That is, in the premium recycling service, the grade of the card to come out is leveled up in proportion to the number, price, and grade of the recycling coupon, and in the general recycling rather than the premium recycling, the card is issued within a predetermined range of the mean value of his owned cards.

Accordingly, the probability for the user to use the premium recycling service may be increased and the recycling service is further activated to accelerate consumption of the recycling coupons in addition to consumption of the uniform cards owned by the user, and he will buy the items of as many as the uniform cards that have disappeared, which will lead to a virtuous cycle of an increase of sales of items.

FIG. 7 shows a premium recycling service according to an exemplary embodiment of the present invention. As shown in FIG. 7, recycling of a uniform card represents selecting a uniform card that is not in use from among the uniform cards owned by him and randomly acquiring a new uniform card.

When progressing in order of: uniform card auction at a top right of a client->my uniform card->recycling tab \textcircled{1}, five uniform cards desiring a recycling are selected from among the owned uniform cards, and a player and a team of the selected uniform card, a position, a card grade, and a uniform card type can be checked below the recycling tab \textcircled{2}.

When he checks the five selected uniform cards and presses a recycling button provided at a right bottom, a uniform card of a specific player is randomly supplied and the used uniform card is removed from an owned list, thereby defining it as an item consuming item \textcircled{3}.

A uniform card higher by two to three stages can be acquired with a low probability when the uniform card with the same grade is recycled upon recycling, for example, when a general card is recycled, a high card is acquirable with a very low probability, and the probability to acquire the uniform card with a high stat is increased when the stat that is an average capability point of the uniform card used to recycling becomes higher.

Here, in the case of the premium recycling service, although not shown, when an owned list of the recycling coupons is illustrated and premium recycling is performed, the probability to acquire a good card is gradually increased and the users will accordingly buy recycling coupons in order to make great profits with less investment, so by activating the item that is called a recycling coupon and performing the recycling more times, consumption of the items is maximized and the virtuous cycle leading to an increase of sales of items can be achieved.

Here, the premium recycling service according to an exemplary embodiment of the present invention, although not shown, shows it to the user that the probability to acquire a good card is increased according to the grade and the price of the uniform card, so the users recognize that they will obtain better results of as many as they invested compared to the unconfirmed results such as lottery, and it can build reliability for the game company.

Further, when the user may dislike the item as well as the uniform card and desires to exchange it with another card, they can invest more by explicitly illustrating to them that the probability to have a good card come out is increased when they invest further through the service, and consumption of the items and uniform cards can be maximized thereby forming a virtuous cycle that leads to an increase of sales of the items and uniform cards.

The method for providing a premium recycling service according to an exemplary embodiment of the present invention can be performed by an application (which may include a program included in a platform or an operating system mounted as a default on the terminal) installed in the terminal as a default, and it can also be performed by an application (i.e., a program) directly installed in a master terminal by the user through an application store server or an application providing server such as a web server relating to the application or a corresponding service.

In this meaning, the above-described method for providing a premium recycling service according to an embodiment of the present invention may be installed in the terminal as a default, or it may be realized as an application (i.e., program) directly installed by the user and may be recorded on a computer readable medium.

A program realizing a method for providing a premium recycling service according to an exemplary embodiment of the present invention realizes: a function for, when a user buys a uniform card, allowing a server to record data of the bought uniform card by matching the same and an ID, which is a proper identification code of the user; a function for, when the user does not use the uniform card and the user attempts to recycle it, allowing the server to receive the uniform card to be recycled from the user; and a function for, when the user owns a recycling coupon, providing a uniform card with a price and grade corresponding to a predetermined range of a mean value (B) that is a sum of a mean value (A) of values caused by the price and grade of the input uniform card and a predetermined value (α) to the user.

The programs are recorded in the computer readable recording medium and are executed by the computer, such that the above-mentioned functions may be executed.

As described, in order to perform a method for a computer to read a program recorded on a recordable medium and provide a group enjoying service on a contents list realized as a program, the above-mentioned programs may include codes which are coded with computer languages such as C, C++, JAVA, machine language, and the like which may be read by a processor (CPU) of the computer.

The code may include a function code associated with a function of defining the above-mentioned functions, and may also include an execution procedure related control code required to allow the processor of the computer to execute the above-mentioned functions as a predetermined procedure.

Further, the code may further include a memory reference related code indicating at which location (address number) of the memory inside or outside the computer additional information or media required to allow the processor of the computer to execute the above-mentioned functions are referenced.

Further, to allow the processor of the computer to execute the above-mentioned functions, when the processor needs to communicate with any other computers or servers, etc. at a remote location, the code may further include a communication related code about how the processor of the computer communicates with any other computers or servers at a remote location or what information or media the processor of the computer transmits and receives at the time of the communication, by using the communication module (for example, wired and/or wireless communication module) of the computer.

Further, a functional program for implementing the present invention, a code and a code segment associated therewith, and the like may be easily inferred or changed by programmers in the art to which the present invention pertains in consideration of a system environment of the computer which reads the recording medium and executes the program.

Hereinabove, examples of a computer readable recording medium recorded with programs as described above include a ROM, a RAM, a CD-ROM, a magnetic tape, a floppy disk, an optical media storage device, and the like.

Further, a computer readable recording medium recorded with programs as described above may be distributed to a computer system connected through a network and thus stores and executes a computer readable code in a distributed manner. In this case, at least any one computer among a plurality of distributed computers may execute a part of the above-mentioned functions and transmit the executed results to at least one of other distributed computers, and the computer receiving the result may also execute a part of the above-mentioned functions and provide the executed results to other distributed computers.

Particularly, a computer readable recording medium recorded with applications which are programs for executing the method for providing an online game control service according to the exemplary embodiment of the present invention may be a storage medium (for example, a hard disk and the like) included in an application store server or an application providing server such as a web server associated with applications or corresponding services, and the like, or an application providing server itself.

A computer which may read a recording medium recorded with applications which are programs for executing the method for providing an online game control service according to the exemplary embodiment of the present invention may include not only general PCs such as a typical desktop and a laptop, but also mobile terminals such as a smart phone, a tablet PC, a personal digital assistants (PDA), and a mobile communication terminal, and is to be construed as all the computable devices.

Further, when a computer which may read a recording medium recorded with applications which are programs for executing the method for providing an online game control service according to the exemplary embodiment of the present invention is a mobile terminal such as a smart phone, a tablet PC, a personal digital assistant (PDA), and a mobile communication terminal, the applications are downloaded from an application providing server to a general PC and thus may also be installed in the mobile terminal by a synchronization program.

The exemplary embodiments of the present invention may be realized into a program instruction format executable by various computer means and may be recorded on a computer readable medium. The computer readable medium may include a program instruction, file data, and data structures, or combinations thereof. The program instruction recorded on the medium may be those that are designed and configured for the present invention, or those that are known to a person of ordinary skill in the art of computer software and are usable. Examples of the computer readable medium include magnetic media such as a hard disk drive, a floppy disk, or a magnetic tape, optical media such as a CD-ROM or a DVD, magneto-optical media such as a floptical disk, and a hardware device specially configured to store and execute program instructions such as a ROM, a RAM, or a flash memory. Examples of the program instruction include high-level language codes executable by a computer by using an interpreter in addition to machine language codes generated by a compiler. The hardware device can be configured to be operable as at least one software module for performing an operation of the present invention.

The embodiments of the present invention allow \textcircled{1} considering a fact that a user does not use an item when the item he does not desire comes out, providing an item for recycling an item to him, and increasing interest in the game, \textcircled{2} in addition to using a recycling item, further generating a recycling coupon so as to make a card coming out of a recycling item a better card, and allowing him to efficiently use a recycling service by allowing a recycling card with a higher numeric value to come out for the user who owns a recycling coupon, and \textcircled{3} increasing a number of users who use a premium recycling service for activating recycling and applying a recycling coupon when a recycling card with a higher numeric value may come out in the case of a user who owns a recycling coupon, and thereby increasing sales with a virtuous circulation that activates item purchases.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method for providing a premium recycling service in a method for providing a premium recycling service executed by a server, comprising:
a first stage for, when a user buys a uniform card, matching it with an ID, a proper identification code of the user, and recording data of the bought uniform card;
a second stage for, when there is an attempt to recycle an unused uniform card, receiving a uniform card to be recycled from the user; and
a third stage for, when the user owns a recycling coupon, providing a uniform card with a price and a grade (hereinafter, recycling uniform card value) that are greater than an average price and a grade (hereinafter, average uniform card value) of the input uniform card to the user.

2. The method of claim 1, wherein
the recycling uniform card value is increased in proportion to a number of input uniform cards.

3. The method of claim 1, wherein
the recycling uniform card value can correspond to a predetermined range that is higher than the average uniform card value with a first probability or can correspond to a range that is higher than the predetermined range with a second probability, and the first probability is greater than the second probability.

4. The method of claim 1, wherein the third stage further includes
a stage for, when the user owns the recycling coupon, matching it with the ID and storing data of a recycling coupon.

5. The method of claim 1, wherein the third stage further includes
a stage for, when the user owns the recycling coupon, matching data of the uniform card and data of the recycling coupon, and storing them.

6. The method of claim 1, wherein the third stage includes
randomly supplying one of uniform cards corresponding to a predetermined range.

7. The method of claim 1, wherein the third stage further includes
a stage for displaying a probability on a specific card to come out as a result of the recycling in proportion to a price of the input uniform card, a mean value caused by a grade, and a number to the user.

8. The method of claim 7, wherein
the probability is increased in a linear or stepwise manner in proportion to a price of the input uniform card, a mean value caused by a grade, and a number to the user.

9. The method of claim 7, wherein the third stage includes
each time the uniform card is put into a recycling box one by one, showing a probability that is increased according to at least one of the grade and the price of the uniform card to the user.

10. The method of claim 7, wherein the specific card corresponds to a card with a price and a grade exceeding a predetermined range than at least one value of the uniform card the user put into a recycling box, the price of the item, and the grade.

11. In a recordable medium for recording a program for providing a premium recycling service executed by a server, a recordable medium comprising:
a function for, when a user buys a uniform card, matching it with an ID, a proper identification code of the user, and recording data of the bought uniform card;
a function for, when there is an attempt to recycle an unused uniform card, receiving a uniform card to be recycled from the user; and
a function for, when the user owns a recycling coupon, providing a uniform card with a price and a grade (hereinafter, recycling uniform card value) that are greater than an average price and a grade (hereinafter, average uniform card value) of the input uniform card to the user.

12. A server for providing a premium recycling service, comprising:
a communicator connected in a wired or wireless manner for transmitting/receiving data;
a controller for controlling respective constituent elements;
a storage unit for, when a user buys a uniform card and a recycling coupon through the communicator, matching the same with the user's ID, and storing the same; and
a recycling service provider for, when the user's request to recycle a uniform card is input to the communicator, allowing the controller to output the ID that is input to the storage unit and data of the uniform card according to the request that is input through the communicator, receiving the same, and outputting a recycling result.
